(19) United States
(12) Patent Application Publication
(10) Pub. No.: US 2010/0186860 A1
(43) Pub. Date: Jul. 29, 2010

(54) TREAD FOR A RADIAL MEDIUM TRUCK TIRE

(76) Inventors: Francois Pierre Charles Gerard Georges, Stavelot (BE); Vincent Benoit Mathonet, Habay la Neuve (BE); Alain Joseph Jose Godefroid, Meix le Tige (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/359,375

(22) Filed: Jan. 26, 2009

(51) Int. Cl. B60C 11/12; B60C 11/13

(52) U.S. Cl. 152/209.18

(57) ABSTRACT

A pneumatic tire includes a casing and a tread. A set of first sipes of a first rib extend both axially and circumferentially from a first groove toward an edge of the tread. A set of second sipes of a second rib extend both axially and circumferentially from both the first groove toward a centerline of the tread and from a second groove toward an edge of the tread. A set of third sipes of a third rib extends both axially and circumferentially from both the second groove toward the centerline of the tread and from a third groove toward the centerline of the tread. A set of fourth sipes of a fourth rib extends both axially and circumferentially from both the third groove toward an edge of the tread and from a fourth groove toward the centerline of the tread. A set of fifth sipes of a fifth rib extends both axially and circumferentially from the fourth groove toward an edge of the tread.

### FIELD OF INVENTION

The present invention relates to truck tires and, more specifically, to lower rolling resistance truck tires for trailers.

### BACKGROUND OF THE PRESENT INVENTION

The use of treads specifically designed for an axle of truck tires is well known. It is also known, however, that improvements are desired. First, stones may become trapped or held within the grooves of the tread. Such stones may damage the groove bottoms and the belt-package that lies beneath the tread. Such damage caused by stones is known as “stone drilling.”

Second, irregular wear may occur in the shoulder ribs of steer tires. Such irregular shoulder wear may produce peaking on the inside edge of a shoulder rib and drop off on the outside edge of the shoulder rib.

Third, even though cure molds used to produce steer tires are typically made with equal width shoulder and centerline grooves, those tires, when in use, may produce a footprint having shoulder grooves that are opened-up, or greater in width, than the centerline grooves. This opening of the shoulder grooves relative to the centerline grooves may result in a lower local net-to-gross ratio. Since the same load must be carried, the footprint length increases locally, yielding peaking around the shoulder grooves.

One conventional tire provides circumferential grooves that are wide enough to permit measurement of full intended non-skid depth by a tread gauge, yet narrow enough to prevent stones of significant size to enter the circumferential grooves.

### SUMMARY OF THE INVENTION

A pneumatic tire in accordance with the present invention includes a casing for supporting the pneumatic tire for rotation about an axis and a tread attached to the casing for contacting a surface. The tread includes a first rib, a second rib, a third rib, a fourth rib, and a fifth rib. A set of first sipes of the first rib extend both axially and circumferentially from a first groove toward an edge of the tread. The first sipes extend from the first groove in a first circumferential direction to define a first angle relative to a plane extending through the axis of the pneumatic tire. A set of second sipes of the second rib extend both axially and circumferentially from both the first groove toward a centerline of the tread and from a second groove toward an edge of the tread. A first group of the second sipes defines a second angle relative to the plane extending through the axis. The first group of second sipes extends from the first circumferential groove in the first circumferential direction. A second group of the second sipes defines a third angle relative to the plane extending through the axis of the tire. The second group of second sipes extends from the second groove in a second circumferential direction opposite to first circumferential direction. A set of third sipes of the third rib extends both axially and circumferentially from both the second groove toward the centerline of the tread and from a third groove toward the centerline of the tread. A first group of the third sipes defines a fourth angle relative to the plane extending through the axis of the pneumatic tire. The first group of third sipes extends from the second groove in the second circumferential direction. A second group of the third sipes defines a fifth angle relative to the plane extending through the axis of the pneumatic tire. The second group of third sipes extends from the third groove in the first circumferential direction. A set of fourth sipes of the fourth rib extends both axially and circumferentially from both the third groove toward an edge of the tread and from a fourth groove toward the centerline of the tread. A first group of the fourth sipes defines a sixth angle relative to the plane extending through the axis of the pneumatic tire. The first group of fourth sipes extends from the third groove in the first circumferential direction. A second group of the fourth sipes defines a seventh angle relative to the plane extending through the axis of the pneumatic tire. The second group of fourth sipes extends from the fourth groove in the second circumferential direction. A set of fifth sipes of the fifth rib extends both axially and circumferentially from the fourth groove toward an edge of the tread. The fifth sipes extend from the fourth groove in the second circumferential direction to define an eighth angle relative to the plane extending through the axis of the pneumatic tire.

Another aspect of the tire of the present invention includes the first groove and the fourth groove having greater axial widths than the second groove and the third groove.

Still another aspect of the tire of the present invention includes the first sipes being blind sipes ending within the first rib.

Yet another aspect of the tire of the present invention includes the second sipes being blind sipes ending within the second rib.

Still another aspect of the tire of the present invention includes the third sipes being blind sipes ending within the third rib.

Yet another aspect of the tire of the present invention includes the fourth sipes being blind sipes ending within the fourth rib.

Still another aspect of the tire of the present invention includes the fifth sipes being blind sipes ending within the fifth rib.

Yet another aspect of the tire of the present invention includes absolute values of the second and third angles being greater than an absolute value of the first angle.

Still another aspect of the tire of the present invention includes absolute values of the second angle being greater than the third angle.

Yet another aspect of the tire of the present invention includes absolute values of the fourth and fifth angles being greater than the absolute value of the first angle.

Still another aspect of the tire of the present invention includes absolute values of the fourth and fifth angles being greater than the second and third angles.

Yet another aspect of the tire of the present invention includes the fourth and fifth angles being equal and opposite.

Still another aspect of the tire of the present invention includes absolute values of the sixth and seventh angles being greater than the absolute value of the first angle.

Yet another aspect of the tire of the present invention includes absolute values of the sixth angle being equal to the third angle, and absolute values of the seventh angle being equal to the second angle.

Still another aspect of the tire of the present invention includes absolute values of the sixth angle being greater than the seventh angle.

Yet another aspect of the tire of the present invention includes the eighth angle being equal and opposite to the first angle.

A tread for a pneumatic tire in accordance with the present invention includes a first rib, a second rib, a third rib, a fourth rib, and a fifth rib. A set of first sipes of the first rib extends both axially and circumferentially from a first groove toward an edge of the tread. The first sipes extend from the first groove in a first circumferential direction to define a first angle relative to a plane extending through the axis of the pneumatic tire. A set of second sipes of the second rib extends both axially and circumferentially from both the first groove toward a centerline of the tread and from a second groove toward an edge of the tread. A first group of the second sipes defines a second angle relative to the plane extending through the axis. The first group of second sipes extends from the first circumferential groove in the first circumferential direction. A second group of the second sipes defines a third angle relative to the plane extending through the axis of the tire. The second group of second sipes extends from the second groove in a second circumferential direction opposite to the first circumferential direction. A set of third sipes of the third rib extends both axially and circumferentially from both the second groove toward the centerline of the tread and from a third groove toward the centerline of the tread. A first group of the third sipes defines a fourth angle relative to the plane extending through the axis of the pneumatic tire. The first group of third sipes extends from the second groove in the second circumferential direction. A second group of the third sipes defines a fifth angle relative to the plane extending through the axis of the pneumatic tire. The second group of third sipes extends from the third groove in the first circumferential direction. A set of fourth sipes of the fourth rib extends both axially and circumferentially from both the third groove toward an edge of the tread and from a fourth groove toward the centerline of the tread. A first group of the fourth sipes defines a sixth angle relative to the plane extending through the axis of the pneumatic tire. The first group of fourth sipes extends from the third groove in the first circumferential direction. A second group of the fourth sipes defines a seventh angle relative to the plane extending through the axis of the pneumatic tire. The second group of fourth sipes extends from the fourth groove in the second circumferential direction. A set of fifth sipes of the fifth rib extends both axially and circumferentially from the fourth groove toward an edge of the tread. The fifth sipes extend from the fourth groove in the second circumferential direction to define an eighth angle relative to the plane extending through the axis of the pneumatic tire.

Another aspect of the tread of the present invention includes all of the sipes having a radial depth of 3 mm.

### BRIEF DESCRIPTIONS OF THE DRAWINGS

The invention will be described by way of example and with reference to the accompanying drawings in which:

FIG. 1 is a schematic front elevation of a tire in accordance with the present invention.

FIG. 2 is a schematic cross-section view of the tire of FIG. 1.

FIG. 3 is a schematic detail view of part of the tire of FIG.

### DEFINITIONS

“Axial” and “axially” means lines or directions that are parallel to the axis of rotation of the tire.

“Block Element” means a tread element defined by a circumferential groove or shoulder and a pair of lateral extending grooves.

“Circumferential” means lines or directions extending along the perimeter of the surface of the annular tread perpendicular to the axial direction.

“Equatorial Plane (EP)” means the plane perpendicular to the tire's axis of rotation and passing through the center of its tread.

“Groove” means an elongated void area in a tread that may extend circumferentially or laterally about the tread in a straight, curved, or zigzag manner. Circumferentially and laterally extending grooves sometimes have common portions. The “groove width” is equal to the tread surface area occupied by a groove or groove portion, the width of which is in question, divided by the length of such groove or groove portion; thus, the groove width is it average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves which they interconnect, they are regarded as forming “tire bars” tending to maintain a rib-like character in the tread region involved.

“Lateral” means an axial direction.

“Net-to-gross ratio” means the total area of ground contracting tread elements between the lateral edges around the entire circumference of the tread divided by the gross area of the entire tread between the lateral edges.

“Radially” and “radially” means directions radially toward or away from the axis of rotation of the tire.

“Radial Ply Tire” means a belted or circumferentially-restricted pneumatic tire in which the ply cords which extend from bead to bead are laid at cord angles between 65 degrees and 90 degrees with respect to the equatorial plane of the tire.

“Rib” means a circumferentially extending strip of rubber of the tread which is defined by at least one circumferential groove and either a second such groove or a lateral edge, the strip being laterally undivided by full-depth grooves.

“Shoulder” means the upper portion of sidewall just below the tread edge; tread shoulder or shoulder rib means that portion of the tread near the shoulder.

“Sipe” means small slots molded into the tread elements of the tire that subdivide the tread surface and improve traction.

“Tread” means a rubber or elastomeric component including that portion of the tire that comes into contact with the road under normal inflation and load.

“Tread element” or “traction element” means a rib or a block element.

### DETAILED DESCRIPTION OF AN EXAMPLE EMBODIMENT

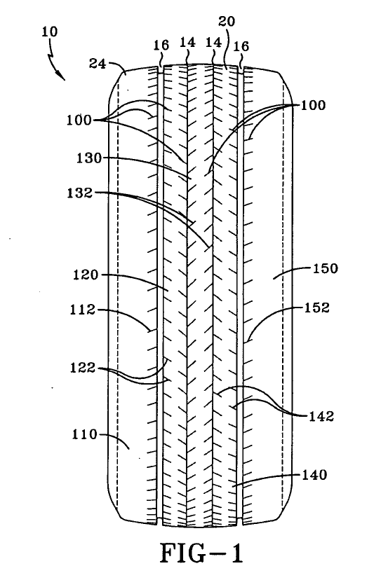

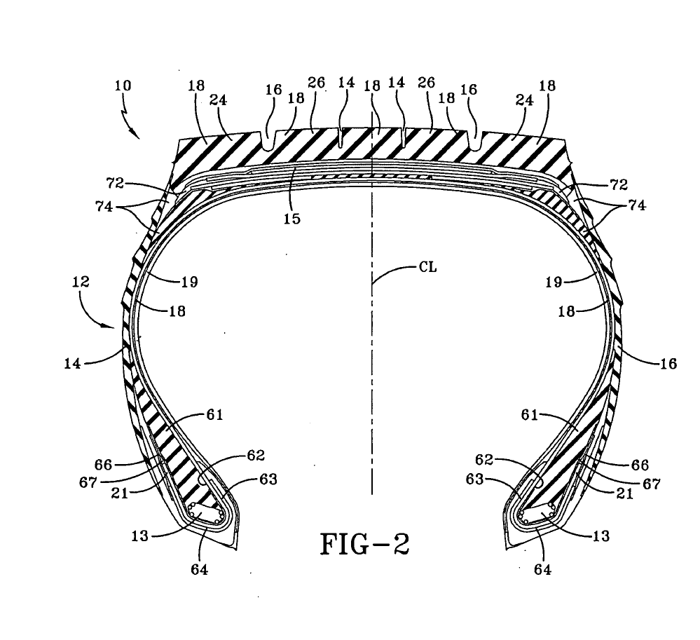

FIGS. 1 and 2 show an example tire 10 for use with the present invention. The tire 10 has a tread 20 and a casing 12. The casing 12 has two sidewalls 14, 16, one or more radial plies 18 extending from, and wrapped about, two annular beads 13, and a belt reinforcement structure 15 located radially between the tread 20 and the ply or plies 18.

The plies 18 and the belt reinforcement structure 15 may be cord reinforced elastomeric material. The cords may be, for example, steel wire filaments and the elastomer may be, for example, a vulcanized rubber material. Similarly, the annular beads 13 may have steel wires wrapped into a bundle forming an inextensible bead core. An innerliner component 19, for example a halobutyl rubber, may form a somewhat air impervious chamber to contain the air pressure when the tire 10 is inflated.

The tire 10 may further include an elastomeric apex 61 radially disposed above each bead 13. A turnup 21 of the ply 18 in each bead area may be reinforced with a flipper 62, a chipper 63, a gum and fabric chafer 64, a gum strip 66, and/or elastomeric wedges 67. Additionally, the belt reinforcement structure 15 may include a gum strip of rubber material 72 and/or a plurality of elastomeric strips or wedges 74 in the lateral extremes or edges of the belt reinforcement structure 15 in proximity of the lateral shoulders of the tread 20. Although not required to the practice of the inventive concept, these features are disclosed as features employed by an example embodiment.

In accordance with the present invention, the tread 20 may have a predetermined non-skid depth and four circumferential grooves including two centerline grooves 14 and two shoulder grooves 16 that divide the tread 20 into five circumferential ribs 18. The shoulder grooves 16 have a greater width than the centerline grooves 14 thereby mitigating groove cracking. The narrower centerline grooves 14 optimize rolling resistance and pressure distribution throughout the tread 20. Laterally extending blind sipes 100 extend at least partially across the five ribs 18 of the tread 20 to form five circumferentially extending ribs 18 including two shoulder ribs 24, two riding ribs 26, and a center rib 28. Further, one end of the blind sipes 100 are enclosed within the edges of the ribs 18 for optimizing wetskid performance.

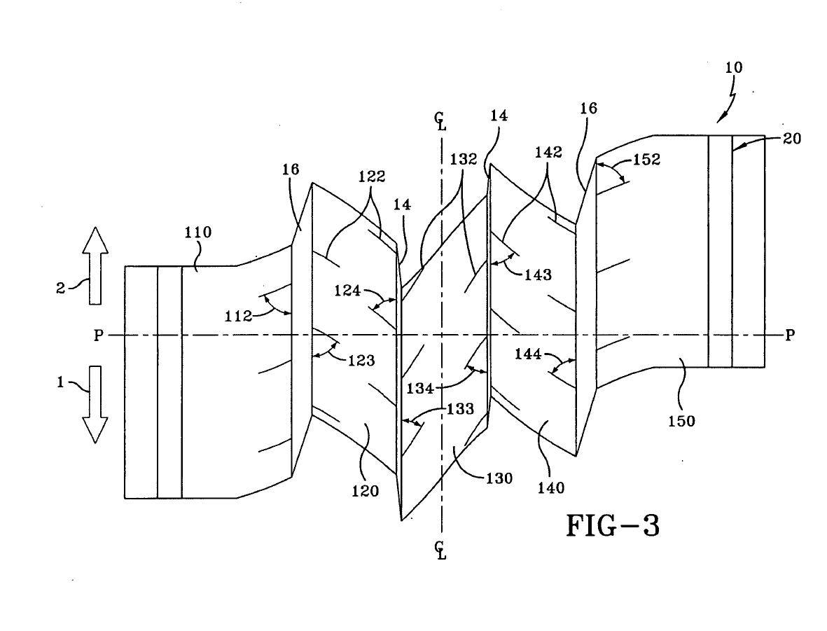

Specifically, as shown in FIG. 3, a set of first sipes 112 of a first, shoulder rib 110 extend both axially and circumferentially from a first, circumferential groove 16 toward an edge of the tread 20. The sipes 112 extend from the first, circumferential groove 16 in a first circumferential direction 1 to define a first angle relative to a plane P extending through an axis of the tire 10.

A set of second sipes 122 of a second, riding rib 120 extend both axially and circumferentially from both the first, circumferential groove 16 toward the centerline CL of the tread 20 and from a second, centerline groove 14 toward an edge of the tread 20. A first group 123 of the second sipes 122 define a second angle relative to the plane P extending through an axis of the tire 10. The first group 123 of second sipes 122 extend from the first, circumferential groove 16 in the first circumferential direction. A second group 124 of the second sipes 122 define a third angle relative to the plane P extending through an axis of the tire 10. The second group 124 of second sipes 122 extend from the second, centerline groove 14 in a second circumferential direction opposite to first circumferential direction. The absolute values of second and third angles are greater than the first angle.

A set of third sipes 132 of a third, riding rib 130 extend both axially and circumferentially from both the second, centerline groove 14 toward the centerline CL of the tread 20 and from a third, centerline groove 14 toward the centerline of the tread. A first group 133 of the third sipes 132 define a fourth angle relative to the plane P extending through an axis of the tire 10. The first group 133 of third sipes 132 extend from the second, centerline groove 14 in the second circumferential direction. A second group 134 of the third sipes 132 define a fifth angle relative to the plane P extending through an axis of the tire 10. The second group 134 of third sipes 132 extend from the third, centerline groove 14 in the first circumferential direction. The absolute values of fourth and fifth angles are greater than the first angle. The fourth and fifth angles are equal and opposite.

A set of fourth sipes 142 of a fourth, riding rib 140 extend both axially and circumferentially from both the third, centerline groove 14 toward an edge of the tread 20 and from a fourth, circumferential groove 16 toward the centerline of the tread. A first group 143 of the fourth sipes 142 define a sixth angle relative to the plane P extending through an axis of the tire 10. The first group 143 of fourth sipes 142 extend from the third, centerline groove 14 in the first circumferential direction. A second group 144 of the fourth sipes 142 define a seventh angle relative to the plane P extending through an axis of the tire 10. The second group 144 of fourth sipes 142 extend from the fourth, circumferential groove 16 in the second circumferential direction. The absolute values of sixth and seventh angles may be greater than the first angle and equal to the second and third angles.

A set of fifth sipes 152 of a fifth, shoulder rib 150 extend both axially and circumferentially from the fourth, circumferential groove 16 toward an edge of the tread 20. The fifth sipes 152 extend from the fourth, circumferential groove 16 in the second circumferential direction to define an eighth angle relative to the plane P extending through an axis of the tire 10. The eighth angle is equal and opposite to the first angle.

The tread 20 provides a new mold shape and tread pattern for a wide base low aspect ratio truck trailer tire. The tread 20 optimizes treadwear, rolling resistance, and wet braking performance with a strong performance in fuel consumption reduction and environmental care. Experiments have shown that the tread 20 in accordance with the present invention may decrease rolling resistance by 10%, increase mileage potential by 5%, and improve wet braking performance by 5% compared to the same tire with a conventional tread. Further, as one example, all of the sipes 112, 122, 132, 142, 152 may have a radial depth of 3 mm.

The five rib construction of the tread 20 with wide shoulder ribs may provide less shoulder wear and increase robustness during maneuvering. The wide shoulder grooves may limit groove overclosure in the footprint, thereby minimizing groove cracking. The narrow centerline grooves at the center of the tire may provide optimum rolling resistance and optimum pressure distribution. The dual angle groove construction may minimize stone holding. The sipes may have 3 mm depth and cut partially across the ribs 18 for improved wetskid performance.

The invention has been described with reference to the example embodiment. Modifications and alterations may occur to others upon a reading and understanding of the specification and claims. It is intended to include all such modifications and alterations in so far as they come within the scope of the appended claims or equivalents thereof.

Having thus described the invention, it is now claimed:

1. A pneumatic tire comprising:
a casing for supporting the pneumatic tire for rotation about an axis; and
a tread attached to the casing for contacting a surface, the tread comprising a first rib, a second rib, a third rib, a fourth rib, and a fifth rib,
a set of first sipes of the first rib extending both axially and circumferentially from a first groove toward an edge of the tread, the first sipes extending from the first groove in a first circumferential direction to define a first angle relative to a plane extending through the axis of the pneumatic tire,
a set of second sipes of the second rib extending both axially and circumferentially from both the first groove toward a centerline of the tread and from a second groove toward an edge of the tread, a first group of the second sipes defining a second angle relative to the plane extending through the axis, the first group of second sipes extending from the first circumferential groove in the first circumferential direction, a second group of the second sipes defining a third angle relative to the plane extending through the axis of the tire, the second group of second sipes extending from the second groove in a second circumferential direction opposite to first circumferential direction,
a set of third sipes of the third rib extending both axially and circumferentially from both the second groove toward the centerline of the tread and from a third groove toward the centerline of the tread, a first group of the third sipes defining a fourth angle relative to the plane extending through the axis of the pneumatic tire, the first group of third sipes extending from the second groove in the second circumferential direction, a second group of the third sipes defining a fifth angle relative to the plane extending through the axis of the pneumatic tire, the second group of third sipes extending from the third groove in the first circumferential direction,
a set of fourth sipes of the fourth rib extending both axially and circumferentially from both the third groove toward an edge of the tread and from a fourth groove toward the centerline of the tread, a first group of the fourth sipes defining a sixth angle relative to the plane extending through the axis of the pneumatic tire, the first group of fourth sipes extending from the third groove in the first circumferential direction, a second group of the fourth sipes defining a seventh angle relative to the plane extending through the axis of the pneumatic tire, the second group of fourth sipes extending from the fourth groove in the second circumferential direction, and
a set of fifth sipes of the fifth rib extending both axially and circumferentially from the fourth groove toward an edge of the tread, the fifth sipes extending from the fourth groove in the second circumferential direction to define an eighth angle relative to the plane extending through the axis of the pneumatic tire.

2. The pneumatic tire as set forth in claim 1 wherein the first groove and the fourth groove have greater axial widths than the second groove and the third groove.

3. The pneumatic tire as set forth in claim 1 wherein the first sipes are blind sipes ending within the first rib.

4. The pneumatic tire as set forth in claim 1 wherein the second sipes are blind sipes ending within the second rib.

5. The pneumatic tire as set forth in claim 1 wherein the third sipes are blind sipes ending within the third rib.

6. The pneumatic tire as set forth in claim 1 wherein the fourth sipes are blind sipes ending within the fourth rib.

7. The pneumatic tire as set forth in claim 1 wherein the fifth sipes are blind sipes ending within the fifth rib.

8. The pneumatic tire as set forth in claim 1 wherein absolute values of the second and third angles are greater than an absolute value of the first angle.

9. The pneumatic tire as set forth in claim 8 wherein absolute values of the third angle are greater than the second angle.

10. The pneumatic tire as set forth in claim 9 wherein absolute values of the fourth and fifth angles are greater than the absolute value of the third angle.

11. The pneumatic tire as set forth in claim 10 wherein absolute values of the fourth and fifth angles are equal.

12. The pneumatic tire as set forth in claim 11 wherein the fourth and fifth angles are equal and opposite.

13. The pneumatic tire as set forth in claim 12 wherein absolute values of the sixth and seventh angles are greater than the absolute value of the first angle.

14. The pneumatic tire as set forth in claim 13 wherein absolute values of the sixth and seventh angles are equal to the second and third angles.

15. The pneumatic tire as set forth in claim 10 wherein absolute values of the sixth angle are greater than the seventh angle.

16. The pneumatic tire as set forth in claim 10 wherein the eighth angle is equal and opposite to the first angle.

17. A tread for a pneumatic tire comprising:
a first rib;
a second rib;
a third rib;
a fourth rib; and
a fifth rib,
a set of first sipes of the first rib extending both axially and circumferentially from a first groove toward an edge of the tread, the first sipes extending from the first groove in a first circumferential direction to define a first angle relative to a plane extending through the axis of the pneumatic tire,
a set of second sipes of the second rib extending both axially and circumferentially from both the first groove toward a centerline of the tread and from a second groove toward an edge of the tread, a first group of the second sipes defining a second angle relative to the plane extending through the axis, the first group of second sipes extending from the first circumferential groove in the first circumferential direction, a second group of the second sipes defining a third angle relative to the plane extending through the axis of the tire, the second group of second sipes extending from the second groove in a second circumferential direction opposite to first circumferential direction,
a set of third sipes of the third rib extending both axially and circumferentially from both the second groove toward the centerline of the tread and from a third groove toward the centerline of the tread, a first group of the third sipes defining a fourth angle relative to the plane extending through the axis of the pneumatic tire, the first group of third sipes extending from the second groove in the second circumferential direction, a second group of the third sipes defining a fifth angle relative to the plane extending through the axis of the pneumatic tire, the second group of third sipes extending from the third groove in the first circumferential direction,
a set of fourth sipes of the fourth rib extending both axially and circumferentially from both the third groove toward an edge of the tread and from a fourth groove toward the centerline of the tread, a first group of the fourth sipes defining a sixth angle relative to the plane extending through the axis of the pneumatic tire, the first group of fourth sipes extending from the third groove in the first circumferential direction, a second group of the fourth sipes defining a seventh angle relative to the plane extending through the axis of the pneumatic tire, the second group of fourth sipes extending from the fourth groove in the second circumferential direction, and
a set of fifth sipes of the fifth rib extending both axially and circumferentially from the fourth groove toward an edge of the tread, the fifth sipes extending from the fourth groove in the second circumferential direction to define an eighth angle relative to the plane extending through the axis of the pneumatic tire.

18. The tread as set forth in claim 17 wherein all of the sipes have a radial depth of 3 mm.
